(19) United States
(12) Patent Application Publication
(10) Pub. No.: US 2017/0173506 A1
(43) Pub. Date: Jun. 22, 2017

(54) FILTER DEVICE WITH DRAINAGE MEANS IN THE COVER

(71) Applicant: Mahle International GmbH, Stuttgart (DE)

(72) Inventors: Engin Genc, Waiblingen (DE); Ralf Kiemlen, Reutlingen (DE)

(21) Appl. No.: 15/115,436

(22) PCT Filed: Jan. 19, 2015
(86) PCT No.: PCT/EP2015/050865

§ 371 Date: Jul. 29, 2016

(30) Foreign Application Priority Data
Jan. 30, 2014 (DE) 10 2014 201 680.0

(51) Int. Cl. B01D 35/16; B01D 29/11; B01D 35/00; B01D 29/96

(52) U.S. Cl. CPC B01D 35/16; B01D 29/96; B01D 29/112; B01D 35/005; B01D 2201/301; B01D 2201/4007

(57) ABSTRACT

A suspended filter device may include a ring filter element arranged in a receiving space. A cover may be securable to a housing from beneath for closing the receiving space. A drainage element may be arranged at the bottom of the cover in an installed state, and a pin may be disposed on the filter element and be configured to close the drainage element. A dome may engage into an interior of the filter element from below when the cover is installed. A guide contour may be disposed on a free end of the dome and interact with a guide element disposed on the filter element. A spring may be supported on the cover and on the dome, and may be configured to prestress the ring filter element in an upward direction into the housing via the dome.

### CROSS-REFERENCE TO RELATED APPLICATIONS

This application claims priority to German Patent Application No. 10 2014 201 680.0, filed Jan. 30, 2014, and International Patent Application No. PCT/EP2015/050865, filed Jan. 19, 2015, both of which are hereby incorporated by reference in their entirety.

### TECHNICAL FIELD

The present invention relates to a filter device, in particular an oil or fuel filter.

### BACKGROUND

From DE 10 2009 049 868 A1 a generic filter device is known, with a ring filter element arranged in a receiving space, with a cover, which in the installed state can be fastened to a housing from beneath for closing the receiving space, having a drainage means which in the installed state is arranged beneath on the cover, through which the receiving space can be drained, and having an eccentrically and axially projecting pin that is arranged on the ring filter element, which closes the drainage means when the ring filter element is inserted in the receiving space and the receiving space is closed with the cover.

From EP 2 635 360 A1 a filter for a liquid medium is known, with a filter housing and a cover that can be detachable connected therewith and having a replaceable ring filter element consisting of a hollow-cylindrical filter material body and two end discs enclosing the same, wherein the ring filter element can be plugged onto a central dome forming a part of the filter housing. On the dome, a locking ring is axially displaceably guided, wherein the locking ring is preloaded with a force which acts in the pushing-out direction facing towards the free end of the dome and wherein the locking ring is blocked against pushing-in in a pushing-out position by a latching device. When the locking ring is in the pushing-out position and the ring filter element located axially bearing against the locking ring, the seal is held away from the associated sealing surface of the filter housing, as a result of which the use of unsuitable ring filter elements is to be rendered at least difficult.

With the generic filter devices, a pin which axially projects from a lower end disc is often arranged on a ring filter element to ensure the use of a suitable ring filter element, by means of which pin the ring filter element with mounted filter device engages in a channel on the filter housing bowl side and starting-up of the filter device is exclusively possible provided that the ring filter element used has the required pin in the correct position. The use, in particular, of unauthorised ring filter elements can thereby be avoided and damage on for example an internal combustion engine be prevented. However, a change of a ring filter element has frequently proved difficult with such filter devices however.

### SUMMARY

The present invention therefore deals with the problem of stating an improved or at least an alternative embodiment for a filter device of the generic type, which on the one hand is simple in construction and on the other hand facilitates changing the ring filter element.

According to the invention, this problem is solved through the subject of the independent claim(s). Advantageous embodiments are subject of the dependent claims.

The present invention is based on the general idea—with a suspended filter device known per se with a ring filter element arranged suspended in a receiving space—to provide both a dome that is spring preloaded from beneath, which preloads the ring filter element upwards into a housing, and also a guiding contour which is arranged on a free end of the first dome, which interacts with a guide element arranged on the ring filter element and brings about alignment of a pin relative to a drainage means, as a result of which exclusively the use of suitable ring filter elements can be achieved. The suspended filter device according to the invention, which can be formed in particular as oil filter for cleaning lubricating oil, in particular for internal combustion engines of motor vehicles, comprises a cover which in the installed state can be fastened to a housing from beneath for closing the receiving space. On the top, on the housing, an inlet and an outlet for the supply and disposal of the filter device can be provided. Beneath, on the cover, a drainage means is arranged through which the receiving space can be drained. On the ring filter element, an eccentrically and axially projecting pin is arranged, which closes the drainage means when the ring filter element is inserted in the receiving space and the receiving space is closed with the cover. On a free end of the first dome a guide contour is provided, which interacts with a guide element arranged on the ring filter element and brings about aligning the pin relative to the drainage means. The spring according to the invention, upon a detaching of the cover, brings about lifting of the ring filter element, as a result of which the pin of said ring filter element is pulled out of the drainage means and releases the same so that the receiving space can drain. At the same time, the ring filter element however remains on the dome of the cover and can in the clean state be simply removed from the same.

With past filter devices, such as are known for example from DE 10 2009 049 868 A1, the ring filter element remained suspended from the housing when the cover was unscrewed, so that the assembler had to hold the contaminated ring filter element with his hands in order to detach it from the housing and change it.

With the solution according to the invention, the spring that is arranged in the cover presses the ring filter element with the moulded-on pin out of the drainage means during the unscrewing, as a result for example the oil drains off although the ring filter element is still on the cover. Consequently, the worker can cleanly remove the ring filter element with the cover. The provision of the spring in this case offers an extremely simple design possibility of cleanly replacing the ring filter element. For installing the ring filter element, this is put over the first dome on the cover. When the cover is screwed on, the spring is preloaded and in the process presses the ring filter element into the housing. Through the elevated friction effect between housing and upper end disc, the ring filter element by means of the guide contour turns in the cover so that the pin engages in the drainage means.

With an advantageous further development of the invention, the length of the spring is dimensioned so that in the relaxed state it lifts the dome and in addition to this the ring filter element so far that on the one hand the pin no longer engages in the drainage means and on the other hand the ring filter element is still held on the first dome. Because of this, particularly simple and additionally clean replacing of the ring filter element is possible.

With an advantageous further development of the solution according to the invention, the guide contour on the dome side comprises an axial groove, towards which the guide element is guided during the assembly of the filter device, and which is arranged relative to the pin on the ring filter element side in such a manner that the same is introduced into the drainage means provided the guide element enters the axial groove. This exact alignment of the pin relative to the guide element and the interaction of the guide element with the guide contour on the dome side brings about that exclusively suitable ring filter elements can be inserted in the filter device, but not other ring filter elements, which for example do not have a pin. With the latter, the drainage means is not closed and a bypass flow bypassing the ring filter element made possible, which greatly reduces the filtering effect of the filter device. When using ring filter elements with pin, both the guide element and also a distance between the same and the pin has to correspond precisely predefined dimensions so that upon interaction of the guide element with the guide contour on the dome side the pin also enters the drainage means provided the guide element is pushed into the axial groove of the guide contour. Generally, the use of unsuitable ring filter elements is at least made greatly more difficult, as a result of which damage on an internal combustion engine connected to the filter device can be reduced or entirely excluded.

With an advantageous further development of the solution according to the invention, the guide contour on the dome is formed in the manner of a bevelled cannula, wherein at the lowest point the axial groove is arranged. In this case, particularly easy feeding of the guide element to the axial groove and thus a particularly easy guiding of the pin to the drainage means can likewise be achieved. In contrast with filter devices known from the prior art, in the case of which the pin on the ring filter element side was often used as sliding element, the pin according to the invention need no longer have such a sliding property and can therefore be formed for example also from an elastic material, in particular from rubber.

Further, important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

There it shows, in each case schematically,

FIG. 1 a filer device according to the invention in a sectional representation,

FIG. 2 a detail representation from FIG. 1 in the region of a spring preloaded dome with preloaded spring,

FIG. 3 a representation as in FIG. 2, however with at least partly relaxed spring,

FIG. 4 an internal view of a cover of the filter device,

FIG. 5 a representation as in FIG. 4, however with partly sectioned dome,

FIG. 6 an exploded representation of the cover of the filter device with spring and dome.

### DETAILED DESCRIPTION

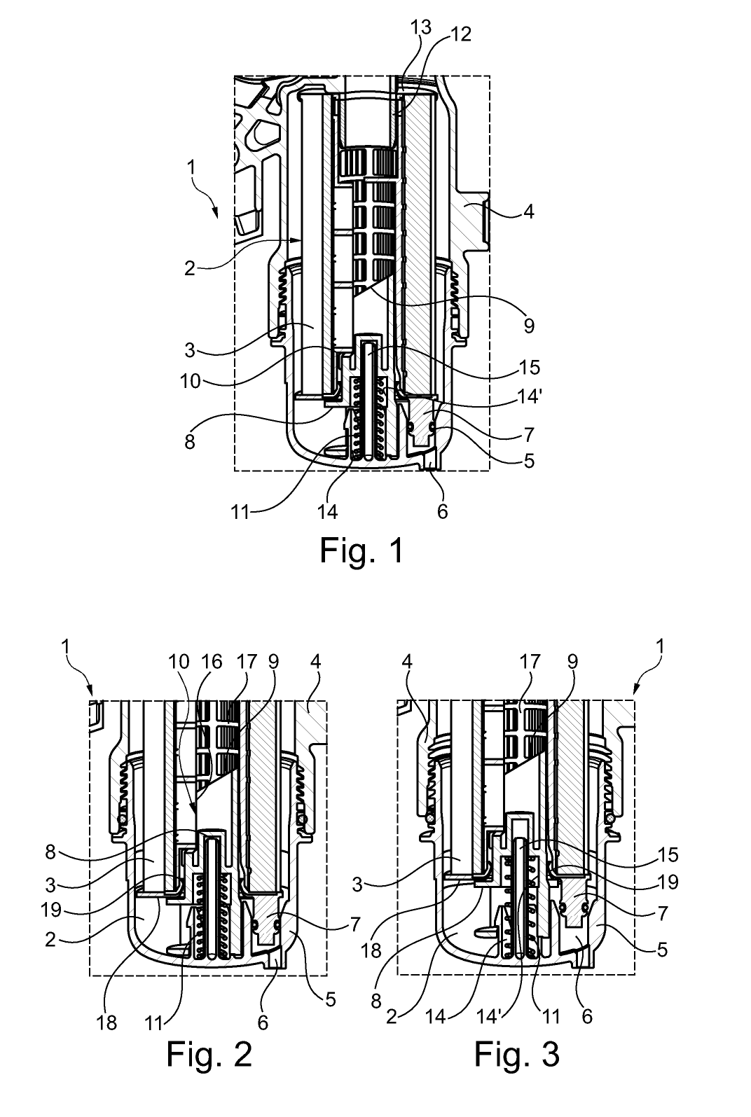

According to FIGS. 1 to 3, a filter device 1 according to the invention, for example an oil or fuel filter, comprises a receiving space 2, in which a ring filter element 3 is arranged suspended. The filter device 1 additionally comprises a housing 4, which can be closed with a cover 5 from beneath. The cover 5 in this case can be screwed to the housing 4 from below. In order to be able to remove the liquid that is present in the housing 4 or in the cover 5 during a change of the ring filter element 3 and thereby drain the receiving space 2, a drainage means 6 is provided below on the cover 5, which, with the filter device 1 ready for operation, is closed by an eccentrically arranged and axially projecting pin 7 on the ring filter element 3. According to the invention, a first tubular dome 8 is additionally provided, which with mounted filter device 1 engages into an interior of the ring filter element 3 from beneath. On an upper free end of the first dome 8 a guide contour 9 is arranged here, which interacts with a guide element 10 that is arranged on the ring filter element 3 and brings about alignment of the pin 7 relative to the drainage means 6. Likewise provided is a spring 11, which supports itself on the one hand on the cover 5 and on the other hand on the dome 8 and via the same preloads the ring filter element 3 upwards into the housing 4. When disconnecting the cover 5, the spring 11 causes the ring filter element 3 to be preloaded upwards into the housing 4 at all times and because of this when screwing the cover 5 downwards is released with its pin 7 from the drainage means 6, as a result of which the fluid, for example oil or fuel that is present in the receiving space 2, can be drained. Even before the cover 5 can thus be completely unscrewed from the housing 4, the receiving space 2 is drained. However, following the unscrewing of the cover 5, i.e. following its disconnection from the housing 4, the ring filter element 3 remains on the first dome 8 and thus on the cover 5, as a result of which easy removal by an assembler or worker is made possible. A new ring filter element 3 is subsequently placed onto the dome 8 in the cover 5, wherein when closing the cover by turning or screwing on the cover 5 the spring 11 is preloaded and because of this pushes the ring filter element 3 into the housing 4 or on a second dome 12 arranged up there. Through the increased friction between the second dome 12 and for example an upper end disc 13 of the ring filter element 3, the ring filter element 3 by way of the guide contour 9 on the first dome 8 or cover 5 turns so that the pin 7 can be introduced into the drainage means 6 in an accurately fitting manner. Compared with suspended filter devices known from the prior art, the ring filter element 3 in the case of the filter device 1 according to the invention, does not remain in the housing 4 following complete unscrewing of the cover 5, but can be simply removed with the cover 5.

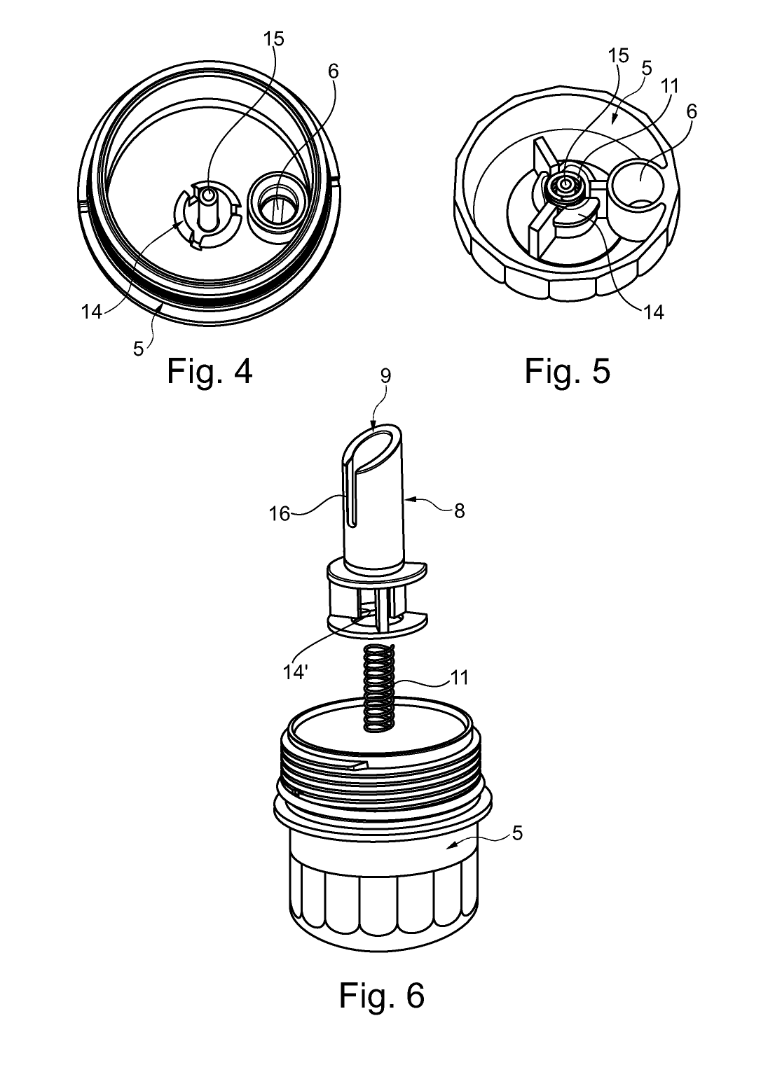

The length of the spring 11 in this case is dimensioned so that in the relaxed state it lifts the first dome 8 and in addition to this the ring filter element 3 so far that on the one hand the pin 7 no longer engages in the drainage means 6 closing the same and on the other hand the ring filter element 3 is still held on the first dome 8. Such a situation is shown for example in FIG. 3. With completely screwed-on cover 5, as is shown for example according to FIGS. 1 and 2, the pin 7 engages in the drainage means 6 thereby closing the same. In the present case, the spring 11 is formed as a coil spring and held in a spring guide contour 14, 14′ both in the cover 5 and also in the first dome 8. The spring guide cover 14 in the cover 5 is clearly evident from FIGS. 1 to 5, whereas the spring contour 14′ on the dome 8 is evident from FIGS. 1 to 3 and 6. The spring guide contour 14 on the cover side engages about the spring 11 and additionally comprises a third dome 15, which engages in the interior of the spring 11. Both the cover 5 and also the first dome 8 can be formed as plastic injection moulding in a cost-effective manner, wherein the respective spring guide contours 14, 14′ are simultaneously injection-moulded on.

Looking at the guide contour 9 on the dome side it is evident that the same has an axial groove 16, to which the guide element 10 is guided during the assembly of the filter device 1. This axial groove 16 is arranged relative to the pin 7 so that the latter can be introduced into the drainage means 6 on the cover side, provided the guide element 10 enters the axial groove 16. The guide contour 9 can be formed in the manner of a bevelled cannula, wherein the axial groove 16 is arranged on the lowest point. The guide element 10 can for example be formed as a guide pin which is directed radially to the inside or radially to the outside. In the present case, the guide element 10 is arranged on a support structure-like internal frame 17 of the ring filter element 3, wherein this internal frame 17 is enclosed on the face end by the upper end disc 13 and a lower end disc 18.

On the lower end disc 18, which is adjacent to the guide element 10, a sealing lip 19 is arranged, which with installed ring filter element 3 sealingly bears against an outer surface of the tubular first dome 8 and thereby fluidically separates an interior from an exterior. The end disc 18 and the sealing lip 19 in this case can be preferentially formed in one piece, in particular as a one-piece plastic injection moulding.

With the filter device 1 according to the invention it is possible for the first time, with suspended filter housings 4, to make possible a low-contamination and thereby clean replacement of the ring filter element 3. With previous filter devices with suspended filter housings, a drainage screw had to be opened before opening the cover in order to remove for example the old oil from the receiving space. Although embodiments were known in the case of which an axially projecting pin that is eccentrically moulded onto an end disc closes a drainage means in the cover, both embodiments however had in common that after the removal of the cover the ring filter element remained suspended in the filter bowl, i.e. in the present case in the housing 4, and the worker therefore had to hold the smudgy ring filter element with his hands in order to change it. With the filter device 1 according to the invention this is no longer necessary since when screwing on the cover 5 the spring 11 provided according to the invention lifts the ring filter element 3 and extracts the pin 7 from the drainage means 6, as a result of which the fluid, for example oil, that is present in the receiving space 2 can be drained. Following drainage of the receiving space 2, the cover 5 can be completely unscrewed and removed, wherein in this case the ring filter element 3 remains on the dome 8 on the cover 5 and can therefore be easily changed.

When unscrewing the cover 5, the ring filter element 3 is disconnected from the housing 4 since the ring filter element 3 during the rotary movement is still fixed by the pin 7 in the drainage means 6 and the retaining forces of the upper O-ring located between ring filter element 3 and dome 12 are relaxed. In order to further amplify the disconnecting effect, the middle upper mounting could be additionally embodied conical, as a result of which the contact between ring filter element 3 and housing 4 when turning on is lost very early on.

The assembly of a new ring filter element 3 is similarly easy since the same need to be merely placed onto the dome 8 on the cover 5 and subsequently the cover 5 screwed to the housing. By means of the guide contour 9 and the guide element 10, alignment of the pin 7 relative to the drainage means then takes place, so that the pin 7 with completely screwed-on cover 5 is sealingly pushed into the drainage means 6.

1. A suspended filter device, comprising:
a ring filter element arranged in a receiving space,
a cover and a housing, wherein the cover in an installed state for closing the receiving space is securable to the housing from beneath,
wherein the housing includes an inlet and an outlet,
a drainage element arranged in the installed state below the ring filter element on the cover through which the receiving space can be drained,
an eccentrically and axially projecting pin arranged on the ring filter element, wherein the pin closes the drainage element when the ring filter element is inserted in the receiving space and the receiving space is closed with the cover,
tubular dome that engages into an interior of the ring filter element from below when the cover is installed,
a guide contour disposed on a free end of the dome, wherein the guide contour interacts with a guide element that is arranged on the ring filter element and facilitates an alignment of the pin relative to the drainage element,
a spring arranged between the cover and the ring filter element, wherein the spring is supported on the cover and on the dome and the ring filter element is preloaded upwards into the housing via the dome,
wherein the guide contour on the dome includes an axial groove, wherein the axial groove guides the guide element during assembly and is arranged relative to the pin so that the pin is insertable into the drainage element on a cover side when the guide element engages the axial groove,
wherein the guide contour is configured as a bevelled cannula, and wherein the axial groove is arranged on a low point of the bevelled cannula, and
wherein at least one of:
the filter element is connected in a torque-proof manner with the cover and is axially displaceable when opening or closing the cover, and
the filter element is removable together with the cover from the housing and the filter element is removable from the cover via a pulling force.

2. The filter device according to claim 1, wherein the spring is configured so that in a relaxed state the spring lifts the dome and the ring filter element an extent sufficient for the pin to disengage from the drainage element and the ring filter element is still held on the dome.

3. The filter device according to claim 1, wherein the spring includes a coil spring and is held in a spring guide contour arranged both in the cover and the dome.

4. The filter device according to claim 1, wherein the guide element includes a guide pin which is directed radially inwards or radially outwards.

5. The filter device according to claim 1, wherein the guide element is arranged on a support structure-like internal frame of the ring filter element, and wherein the internal frame is enclosed at an end face by a respective end disc.

6. The filter device according to claim 1, further comprising a sealing lip arranged at least on the end disc that is proximate to the guide element wherein the sealing lip sealingly bears against an outer surface of the tubular dome when the ring filter element is installed.

7. The filter device according to claim 6, wherein the end disc and the sealing lip are formed in one piece.

8. The filter device according to claim 1, further comprising another tubular dome disposed on the housing and arranged to engage in the interior of the ring filter element from the top.

9. The filter device according to claim 1, wherein the guide element is a guide pin.

10. The filter device according to claim 9, wherein the guide pin is arranged on an internal frame of the ring filter element.

11. The filter device according to claim 10, further comprising an end disc coupled to an end face of the ring filter element, wherein the end disc includes a sealing lip that sealingly bears against an outer surface of the dome when the ring filter element is installed.

12. The filter device according to claim 2, wherein the spring is a coil spring.

13. The filter device according to claim 12, wherein the coil spring is mounted in a spring guide contour, and wherein the spring guide contour is disposed in at least one of the cover and the dome.

14. A suspended filter device for an internal combustion engine, comprising:
a housing including an inlet and an outlet;
a ring filter element arranged in a receiving space;
a cover for closing the receiving space and securable to the housing;
a drainage element disposed on the cover and arranged beneath the ring filter element for draining the receiving space;
an axially projecting pin arranged eccentrically on the ring filter element, wherein the pin closes the drainage element when the ring filter element is inserted into the receiving space and the receiving space is closed by the cover;
a guide element arranged on the ring filter element;
a tubular dome arranged to engage into an interior of the ring filter element when the cover is installed, wherein the dome has a free end that includes a guide contour configured to interact with the guide element and facilitate an alignment of the pin relative to the drainage element;
a spring arranged between the cover and the ring filter element when the cover is installed, wherein the spring is supported on the cover and the dome so that the ring filter element is preloaded upwards into the housing via the dome;
wherein the guide contour includes an axial groove configured to guide the guide element during assembly, wherein the axial groove is arranged so that the pin is insertable into the drainage element on a cover side when the guide element engages the axial groove; and
wherein the guide contour is configured as a beveled cannula, and wherein the axial groove is arranged on a low point of the beveled cannula.

15. The filter device according to claim 14, wherein the filter element is connected with the cover in a torque-proof manner.

16. The filter device according to claim 15, wherein the filter element is axially displaceable only when opening or closing the cover.

17. The filter device according to claim 15, wherein the filter element is removable together with the cover from the housing, and wherein the filter element is removable from the cover via a pulling force.

18. The filter device according to claim 14, wherein the filter element is removable together with the cover from the housing, and wherein the filter element is removable from the cover via a pulling force.

19. The filter device according to claim 14, wherein the spring has a length dimensioned in a relaxed state to lift the dome together with the ring filter element an extent sufficient for the pin to disengage from the drainage element and the ring filter element is still held on the dome.

20. The filter device according to claim 14, wherein the spring is mounted in a spring guide contour arranged in at least one of the cover and the dome.
